(19) United States
(12) Patent Application Publication
(10) Pub. No.: US 2015/0173861 A1
(43) Pub. Date: Jun. 25, 2015

(54) LOCKING TAPER ABUTMENT PROVIDED WITH WEAKENED ZONE

(71) Applicant: Chih-Chung Ho, Kaohsiung (TW)

(72) Inventor: Chih-Chung Ho, Kaohsiung (TW)

(21) Appl. No.: 14/413,195

(22) PCT Filed: Jul. 11, 2012
(86) PCT No.: PCT/CN2012/078503

§ 371 Date: Jan. 6, 2015

(51) Int. Cl. A61C 8/00

(52) U.S. Cl. CPC A61C 8/008; A61C 8/0042

(57) ABSTRACT

A locking taper abutment provided with a weakened zone, having three parts. The first part is disposed in an opening of a dental implant, and connected in a threadless manner. The second part is connected to the first part, and is provided with a structural weakened zone and a protruding portion. The protruding portion is arranged under the structural weakened zone. The third part is connected to the second part for linking a dental prosthesis. The locking taper abutment fractures at the structural weakened zone, and the remaining protruding portion can be directly and easily clamped out with an instrument, without hurting an inner opening wall of the dental implant and without damaging bacterial closure of the dental implant.

### FIELD OF THE INVENTION

The present invention relates to a locking taper abutment and particularly to a locking taper abutment provided with a weakened zone.

### BACKGROUND OF THE INVENTION

Refer to FIGS. 1 and 2 for a conventional locking taper abutment and a dental implant for coupling together. The locking taper abutment 10 includes a first part 11, a second part 12 and a third part 13. The dental implant 20 includes an opening 21.

For coupling the locking taper abutment 10 and the dental implant 20 together, the first part 11 of the abutment 10 is formed in a conical shape with an angle b slightly greater than the angle a of the opening 21 to form secure coupling between them. Such a structure is simple and is easy in operation, and also provides desired bacterial closure so that no unpleasant odor is generated after it is implanted on a patient.

Refer to FIG. 3 for the conventional locking taper abutment in a fractured condition. After the abutment 10 is fractured, the first part 11 remained and held in the dental implant 20 is smaller in size and located proximate to the upper end of the opening 21, hence is difficult to be removed directly via instruments. A hole has to be drilled on the remained first part 11 for removing. This not only makes clinical operation difficult, also is prone to hurt the inner opening wall of the dental implant 20 and damage the bacterial closure thereof.

Thus, there is still a need to provide an innovative locking taper abutment with a weakened zone to solve the aforesaid problems.

### SUMMARY OF THE INVENTION

The primary object of the present invention is to provide a locking taper abutment provided with a weakened zone to overcome the shortcomings occurred to the conventional technique.

To achieve the foregoing object, the locking taper abutment with a weakened zone according to the invention includes a first part, a second part and a third part. The first part is disposed in an opening of a dental implant and coupled with the dental implant in a threadless manner. The second part is connected to the first part and has a structural weakened zone and a protruding portion. The structural weakened zone allows the possible fracture of the locking taper abutment to take place at the structural weakened zone. The protruding portion is located under the structural weakened zone. The third part is connected to the second part to couple with a dental prosthesis.

Through the aforesaid technique, the invention provides many advantages, notably: through the locking taper abutment the second part does not connect to the opening of the dental implant or the dental prosthesis. Through the structural weakened zone the locking taper abutment can be fractured. As the protruding portion is located under the structural weakened zone, after the fracture is formed, the protruding portion still exists on the remained portion of the abutment and can be clamped directly via an instrument and removed in a clinical operation simpler and safer. Thus the difficulty of the clinical operation can be greatly reduced, and damage of the inner opening wall and bacterial closure of the dental implant also can be avoided.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic view of a conventional locking taper abutment and a dental implant.

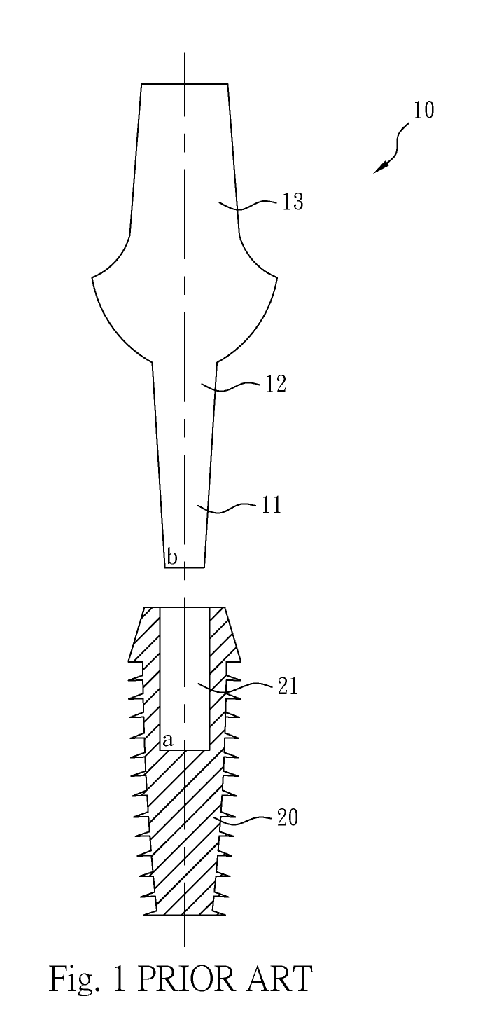

FIG. 2 is a schematic view of a conventional locking taper abutment and a dental implant in a coupled condition.

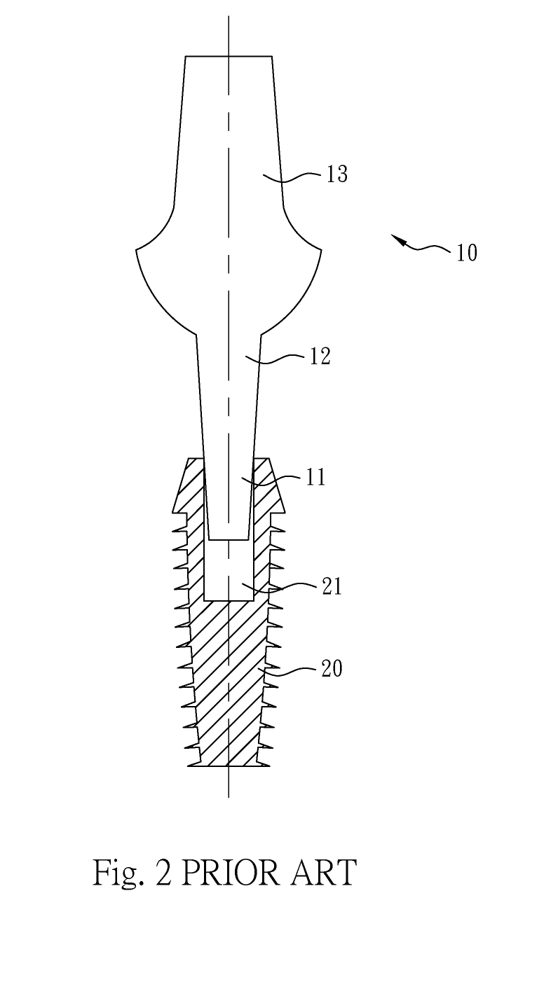

FIG. 3 is a schematic view of a conventional locking taper abutment in a fractured condition.

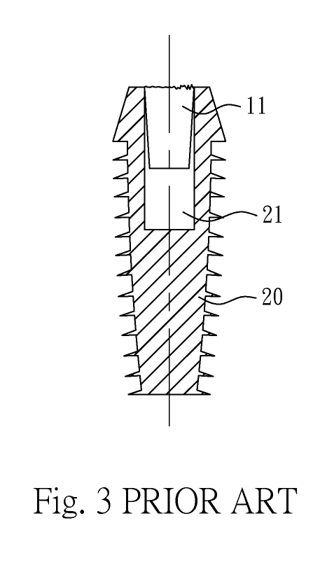

FIG. 4 is a schematic view of a first embodiment of the locking taper abutment with a weakened zone and a dental implant according to the invention.

FIG. 5 is a schematic view of the first embodiment of the locking taper abutment in a fractured condition.

FIG. 6 is a schematic view of a second embodiment of the locking taper abutment with a weakened zone and a dental implant according to the invention.

FIG. 7 is a schematic view of a third embodiment of the locking taper abutment with a weakened zone and a dental implant according to the invention.

FIG. 8 is a schematic view of a fourth embodiment of the locking taper abutment with a weakened zone and a dental implant according to the invention.

### DETAILED DESCRIPTION OF THE PREFERRED EMBODIMENTS

It is to be noted that in the following discussion the terms “upper” and “lower” are not related to gravity. The “upper” means proximity to the occlusal plane or incisive edge of a coupled dental prosthesis, while the “lower” is opposite to the “upper”.

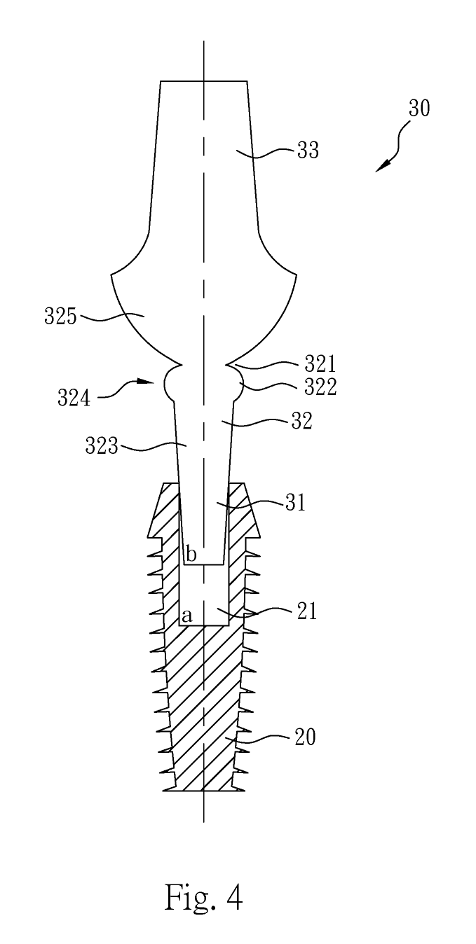

Refer to FIG. 4 for a first embodiment of the locking taper abutment provided with a weakened zone of the present invention. The locking taper abutment 30 includes a first part 31, a second part 32 and a third part 33. The first part 31 is located in an opening 21 of a dental implant 20 and coupled with the dental implant 20 in a threadless manner. In this embodiment the first part 31 is fully sunk in the opening 21. The first part is formed in a conical shape and has an angle b slightly greater than the angle a of the opening 21. Since the first part 31 is coupled with the opening 21 formed at a definite dimension, its diameter and length also are definite.

The second part 32 is connected to the first part 31 and has a structural weakened zone 321 and a protruding portion 322. The structural weakened zone 321 is the location of the locking taper abutment 30 where fracture may take place. The protruding portion 322 is located under the structural weakened zone 321. In this embodiment the structural weakened zone 321 includes at least one recess which extended inwards from an outer circumference of the second part. The structural weakened zone 321 also is formed with a structural strength smaller than that of the first part 31 so that the fracture can take place there rather than on the first part 31.

In this embodiment the second part 32 also includes a bottom area 323, a middle area 324 and a top area 325. The bottom area 323 is connected to the first part 31. The middle area 324 is connected to the bottom area 323. The structural weakened zone 321 and the protruding portion 322 are located on the middle area 324. The top area 325 is connected to the middle area 324 and has a diameter gradually increased to connect to the third part 33.

The third part 33 is connected to the top area 325 of the second part 32 to connect to a dental prosthesis (not shown in the drawings).

In this embodiment the protruding portion 322 is connected to the structural weakened zone 321 and formed in a protruded ring jutting from the middle area 324.

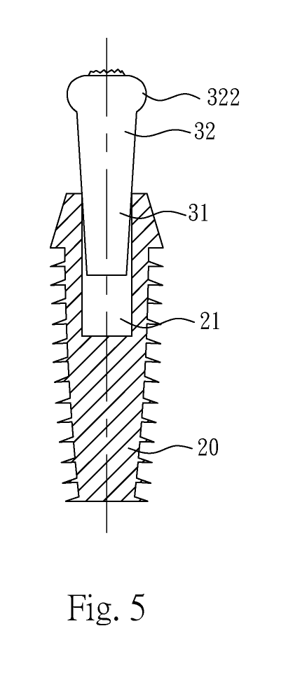

Refer to FIG. 5 for the first embodiment in a fractured condition. When the locking taper abutment 30 is fractured at the structural weakened zone 321, due to the protruding portion 322 is located under the structural weakened zone 321, the remained protruding portion 322 after fracture is located on the remanent locking taper abutment, hence it can be directly clamped and removed via an instrument (not shown in the drawings). Therefore the fractured locking taper abutment (residual of the second part 32 and the first part 31) can be removed easily and safely. The difficulty of the clinical operation can be reduced greatly. Damage of the inner opening wall and bacterial closure of the dental implant 20 also can be avoided.

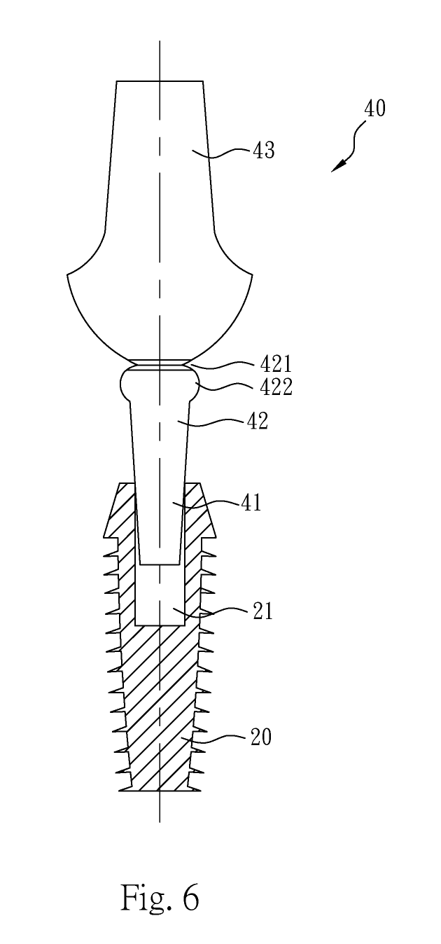

Refer to FIG. 6 for a second embodiment of the locking taper abutment provided with a weakened zone of the invention. The locking taper abutment 40 includes a first part 41, a second part 42 and a third part 43. This embodiment also includes a structural weakened zone 421 which has a recess ring extended inwards from the outer circumference. The recess ring is formed by cutting equally the outer circumference of the second part 42 for 360 degrees. In addition, the locking taper abutment 40 of the second embodiment also includes a protruding portion 422.

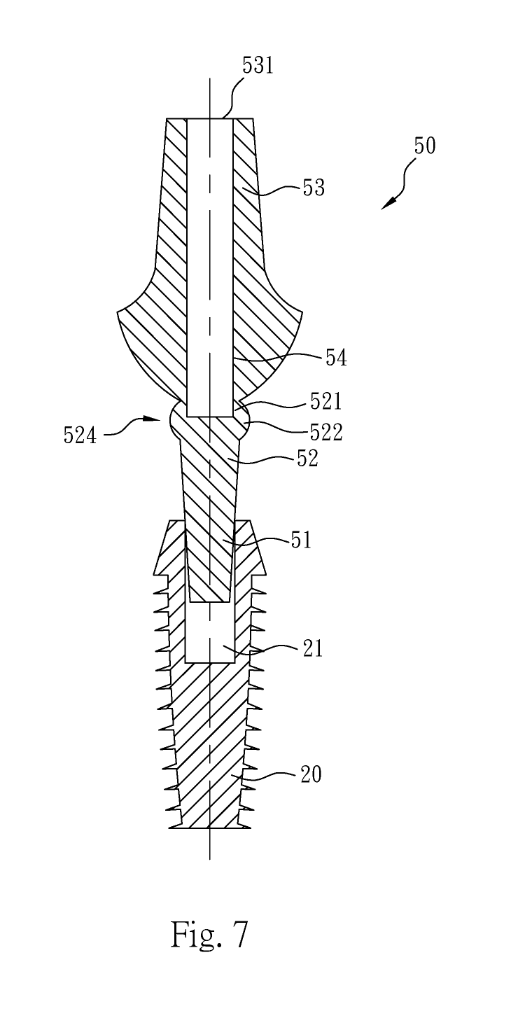

Refer to FIG. 7 for a third embodiment of the locking taper abutment provided with a weakened zone of the invention. The locking taper abutment 50 includes a first part 51, a second part 52 and a third part 53. This embodiment also includes a structural weakened zone 521 which as a hole 54 with an opening 531 at the third part 53 and extended to a middle area 524 of the second part 52. In addition, the locking taper abutment 50 also includes a protruding portion 522.

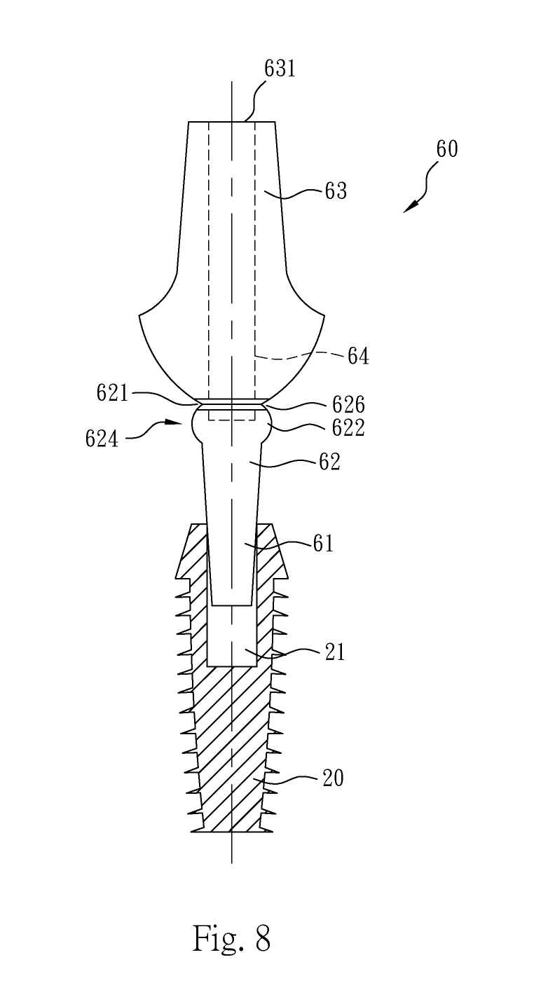

Refer to FIG. 8 for a fourth embodiment of the locking taper abutment provided with a weakened zone of the invention. The locking taper abutment 60 includes a first part 61, a second part 62 and a third part 63. This embodiment also includes a structural weakened zone 621 which has an recess ring 626 and a hole 64. The recess ring 626 is extended inwards from the outer circumference of the second part 62 and formed by cutting equally the outer circumference of the second part 62 for 360 degrees. The hole 64 has an opening 631 at the third part 63 and is extended to a middle area 624 of the second part 62. In addition, the locking taper abutment 60 also includes a protruding portion 622.

This invention, through the structural weakened zone 421 of the locking taper abutment 40 in the second embodiment, the structural weakened zone 521 of the locking taper abutment 50 in the third embodiment and the structural weakened zone 621 of the locking taper abutment 60 in the fourth embodiment, can make the locking taper abutment 40, 50 or 60 to fracture at the structural weakened zone 421, 521 or 621, with the protruding portion 422, 522 or 622 remained on the remanent abutment to be directly clamped and removed via an instrument (not shown in the drawings) to achieve the same effect as the first embodiment does.

While the preferred embodiments of the invention have been set forth for the purpose of disclosure, they are not the limitation of the invention, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A locking taper abutment provided with a weakened zone, comprising:
a first part disposed in an opening of a dental implant and coupled with the dental implant in a threadless manner;
a second part which is connected to the first part and includes a structural weakened zone and a protruding portion located under the structural weakened zone; the structural weakened zone allowing the possible fracture of the locking taper abutment to take place thereat; and
a third part connected to the second part to connect to a dental prosthesis.

2. The locking taper abutment of claim 1, wherein the structural weakened zone includes at least one recess zone extended inwards from an outer circumference of the second part.

3. The locking taper abutment of claim 1, wherein the structural weakened zone includes a recess ring extended inwards from an outer circumference of the second part.

4. The locking taper abutment of claim 1, wherein the protruding portion is connected to the structural weakened zone.

5. The locking taper abutment of claim 1, wherein the protruding portion is a protruded ring.

6. The locking taper abutment of claim 1, wherein the structural weakened zone includes a hole which has an opening at the third part extended to the second part.

7. The locking taper abutment of claim 1, wherein the structural weakened zone includes a recess ring and a hole, the recess ring being extended inwards from an outer circumference of the second part, the hole including an opening at the third part extended to the second part.
